(19) United States
(12) Patent Application Publication
(10) Pub. No.: US 2025/0356446 A1
(43) Pub. Date: Nov. 20, 2025

(54) PERMISSIONS TO PRODUCE ITEMS IN PHYSICAL FORM

(71) Applicant: HEWLETT-PACKARD DEVELOPMENT COMPANY, L.P., Spring, TX (US)

(72) Inventor: Alessandro BELTRAMI, Sant Cugat del Valles (ES)

(73) Assignee: HEWLETT-PACKARD DEVELOPMENT COMPANY, L.P., Spring, TX (US)

(21) Appl. No.: 18/866,809

(22) PCT Filed: May 19, 2022
(86) PCT No.: PCT/US2022/030038

§ 371 Date: Nov. 18, 2024

(51) Int. Cl. G06Q 50/18; G06Q 20/12; G06Q 20/38

(52) U.S. Cl. CPC G06Q 50/184; G06Q 20/1235; G06Q 20/382

(57) ABSTRACT

In an example, processing circuitry may receive a request from a user to produce an item represented by data in a N physical form and an indication of a digital right associated with the item. From the content of the digital right, it may be determined if the user has permission to produce the item in physical form. When the user has permission to produce the item, an apparatus may be instructed to produce the item in physical form.

### BACKGROUND

An item, such as an artwork, document or model of a 3D object, may be represented in data. In some examples, the item may be produced in physical form by printing or manufacturing the item based on instructions created from the data. In some examples, the item may be associated with a right to produce the item in physical form (e.g. by printing an artwork), for example a license or copyright.

### BRIEF DESCRIPTION OF DRAWINGS

Non-limiting examples will now be described with reference to the accompanying drawings, in which:

FIG. 1 is a flowchart of an example method of determining if a user has permission to produce an item in a physical form;

FIG. 2 is a schematic drawing of an example system for implementing methods for determining if a user has permission to produce an item in a physical form;

FIG. 3 is a flowchart of another example method of determining if a user has permission to produce an item in a physical form;

FIG. 4 is a simplified schematic drawing of an example apparatus; and

FIG. 5 is a simplified schematic drawing of an example machine-readable medium associated with a processor.

### DETAILED DESCRIPTION

Production of items may be monitored or controlled in some circumstances. For example, a rights-owner may wish to control how many instances of an item are produced. In some examples, a rights-owner may wish to ensure that an appropriate apparatus is used to produce an item for various reasons such as quality control purposes. Moreover, a rights-owner may wish to facilitate access to apparatus to produce an item. In another example, a rights-holder and/or distributor may wish to increase a detectability of unauthorized copies of the item, or to be able to determine the provenance of an authorized item.

Data may be used to record ownership of rights associated with digital works (i.e. items represented using data). For example, a digital work (e.g. a digital artwork) may have associated ‘digital rights’, i.e. rights represented using data, which may comprise cryptographic components. A digital right, as the term is used herein, may comprise data indicative of an ownership right of data representing an item. One example of such a right is a ‘Non Fungible Token’, or NFT. Such rights may be owned and traded separately from other rights associated with an underlying work. For example, ownership of an NFT of an artwork does not necessarily imply ownership of copyright of the artwork, and therefore ownership of an NFT of an artwork is not associated with a right to produce the artwork in physical form in some examples. However, in examples herein, a digital right may be associated with a right to produce an associated item in physical form, in some examples assuming that certain conditions are satisfied.

Digital rights such as NFTs may exist on a ‘blockchain ledger’, which may be managed using a blockchain platform. In a simple example, a blockchain platform may comprise a blockchain server, at least one blockchain client which may make requests to update a blockchain, and at least one blockchain node (wherein one physical entity may take on more than one of these roles). The blockchain server may store the blockchain ledger, which may comprise an immutable record of transactions (i.e., ‘records’ or ‘blockchain records’) comprising information received from a blockchain client.

To consider a simple example of management of a blockchain, in response to receiving a blockchain record request (e.g., creation of an NFT or a transfer of ownership of an NFT) from a blockchain client, a blockchain node may validate a signature of the received transaction request and any relevant rules. If the transaction request is valid, the request may be added/written to the blockchain ledger at that particular node. Using a ‘consensus protocol’, this process may be carried out at a plurality of blockchain nodes, and the nodes may share their results. Assuming the nodes agree that the request should be allowed, they may propagate changes and derive a blockchain entry that is agreed upon by all parties. A new transaction recorded in the blockchain ledger may be cryptographically linked to a previous transaction in the blockchain ledger (e.g., via a cryptographic hashing function applied to at least part of the information in the previous transaction(s)). The blockchain platform may be configured to ensure that the information stored in the blockchain ledger is secure and immutable (i.e., cannot be changed undetected).

In some examples herein, a digital right, for example an NFT, may be associated with an item which can be produced in a physical form (for example printed or manufactured using additive manufacturing methods or other methods). The digital right may have embedded therein, or associated therewith, a right to produce the item in physical form. In some examples, the right may be encoded as digital data or the like. In some examples, the digital right, including the right to produce the item in physical form, may be verifiable via a blockchain platform. This allows the digital right to provide, encode or evidence a right to produce the item in physical form, which may be controlled. Moreover, the right may in some examples be verifiable, for example in association with the ownership thereof or the like, by means of a public record such as a blockchain.

Some examples herein refer to ‘2D’ printing, i.e. generation of a printed work on a substrate. In other examples, a manufacturing apparatus may execute object creation instructions (also referred to herein as ‘additive manufacturing instructions’) to create an item in three dimensions. Such instructions may be based on data representing the item, e.g. a digital model (such as a computer-aided design) of the item.

An example manufacturing apparatus may implement an additive manufacturing technique (e.g., three-dimensional printing). Example additive manufacturing techniques may generate a three-dimensional object through the solidification of a build material, for example on a layer-by-layer basis. In examples of such techniques, build material may be supplied in a layer-wise manner and the solidification method may include heating the layers of build material to cause melting in selected regions. In other techniques, chemical solidification methods may be used. Thus, an additive manufacturing apparatus may create, or ‘print’, an item in accordance with the object creation instructions. Another example manufacturing apparatus may implement a material-removal technique, selectively removing material from a block of material to create an item in accordance with object creation instructions. Examples of such manufacturing apparatus include computer-numerical control (CNC) milling machines, engraving apparatus, etching apparatus (e.g., for controlling a chemical-based etching process), and the like.

FIG. 1 is an example of a method, which may be a computer implemented method executed by processing circuitry comprising at least one processor. In some examples, the method may be carried out by processing circuitry of an apparatus which is to produce an item in physical form. In other examples, processing circuitry may be associated with such apparatus, or independent therefrom.

Block 102 comprises receiving a request from a user to produce an item represented by data in a physical form and an indication of the digital right associated with the item. For example, this may be a request to print a 2D artwork, manufacture a 3D object or the like. In some examples, the indication of the digital right (or data embodying or encoding the right) may be embedded within, or packaged with, data representing the item (e.g. a digital artwork or digital model). In some examples, the indication of the digital right may for example comprise an identifier or the like, such that data embodying or encoding the digital right may be accessed using the identifier. In some examples, the request may be received with data representing the item itself (e.g. data representing or encoding an image or a 3D model), although in other examples this may be retrieved from some other source.

Block 104 comprises determining, from the content of the digital right, if the user has permission to produce the item in physical form. In some examples, this may comprise verifying the content of the digital right using a blockchain platform. For example, the digital right may comprise or be associated with a cryptographic key or some other identifier, for example a transaction hash, as may be associated with an NFT. An indication of a permission to produce the item in physical form may be provided as part of the digital right stored in a blockchain, or may be provided as a separate part of the blockchain, which can be accessed based on the content of the digital right, for example the transaction hash thereof. In some examples therefore, the digital right and/or any permissions to produce the item in physical form may be publicly available as part of the blockchain. In other examples, the content of a digital right may be accessed in some other way (or may be provided with the data representing the item, as described above).

When the user has permission to produce the item (i.e. the determination in block 104 is positive), block 106 comprises instructing an apparatus to produce the item in physical form. In some examples, this may comprise retrieving the data representing the item, for example based on information provided by the indication of the digital right. For example, the information indicative of the digital right may provide an indication of the blockchain, and the blockchain may store information allowing the data representing the item to be retrieved.

In some examples, when the determination in block 104 is negative, permission to produce the item may be denied.

Moreover, in examples described in greater detail below, the method may continue with updating the blockchain to indicate that the permission has been used (or in some examples that a request has been denied).

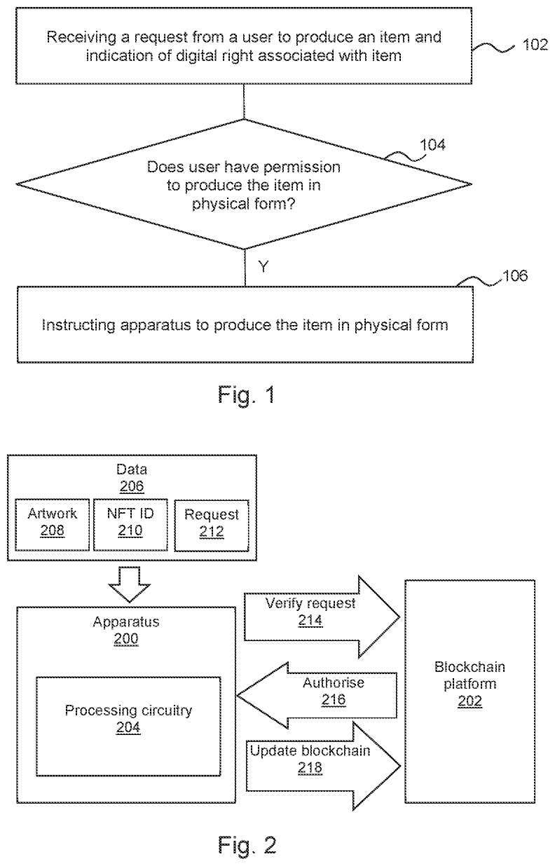

To consider an example of the method of FIG. 1 in greater detail, FIG. 2 is a schematic example of communications between an apparatus 200 verifying a right to produce the item in physical form and a blockchain platform 202. In this example, the apparatus 200 is a print apparatus comprising processing circuitry 204, although in other examples, the apparatus 200 may for example comprise an additive manufacturing apparatus, or any other apparatus capable of producing a physical item from data representing the item. Moreover, in other examples, the processing circuitry 204 may be separate from the apparatus 200 which is to produce the item in physical form.

The initial communication received at the print apparatus 200 is data 206 comprising a representation of the item to be printed (although in other examples, this may be an identifier for such data), in this example a printable digital artwork 208. The data 206 further comprises an identifier 210 for an NFT, indicating a right for the owner of the NFT to print a number of copies, in this example ten copies, of the artwork using a predetermined class of print apparatus. The NFT is associated with a transaction hash (which may serve as the identifier in some examples), uniquely identifying the NFT. Moreover, the data 206 comprises a request 212 to print five copies of the artwork.

It may then be determined if the user has permission to produce the item in physical form by requesting validation of the permission from a blockchain platform. In particular, in this example, the processing circuitry 204 of the print apparatus 200, on receiving the data 206, accesses the blockchain platform 202 to verify that conditions are met (arrow 214). In this example, there are three conditions, although there may be more or fewer conditions in other examples. The first condition is that the request has been received from the owner of the NFT. The second condition is that the NFT is associated with a right to produce at least the requested number of copies. The third condition is that the print apparatus 200 meets any specification set out in the NFT, in this case checking that the print apparatus 200 is of the particular class of print apparatus, matching any class specified in the NFT.

In other examples, a particular individual printer may be indicated by the digital right and, in such an example, verifying the condition(s) may comprise verifying that the individual print apparatus 200 is the specified print apparatus. In some examples, the apparatus 200 may have a cryptographic identity, which may be verified, for example by the blockchain platform 202 before permission to print is granted.

In some examples, it may be that a creator of the work intends for the work to be produced on a particular type or class of apparatus, or a particular apparatus, in order that the artwork/design is produced to an intended standard. In some examples, certain print or manufacturing apparatus may be associated with, for example, a high resolution or particular printing effects which may not be common to all apparatus. Moreover, some print or manufacturing apparatus may use or process materials which may be used/processed by some apparatus and not others.

In order to encourage use of such a suitable apparatus, an NFT or other digital right may be generated and/or traded with an integral right to produce physical representations thereof. In some examples, a digital right may be sold to include the cost of producing a predetermined number of instances of an item. A user may therefore effectively redeem such prepaid services against the NFT. Moreover, if the work was produced on a different apparatus, it may be that it would not have the properties, value and/or artistic merit intended by the original producer of the work, as is further described below.

In summary then, in this example, the apparatus 200 queries the publicly accessible blockchain to determine if the NFT is owned by the user, whether the NFT is associated with an appropriate permission to print the item associated with the NFT and whether the apparatus 200 itself is an authorised apparatus for producing the artwork in physical form.

Assuming that all the conditions are met, in this example the blockchain platform 202 indicates that printing may be authorised (arrow 216). In other examples, the apparatus 200 may make the determination as to whether printing is authorised itself, for example using information accessed from the blockchain platform 202. The print apparatus 200 may proceed with printing five copies of the printable item.

In this example therefore the apparatus 200 may determine if it is authorized to print the item, wherein the authorization is associated with, or encoded/embedded in, a digital right. In some examples, the authorizing entity may be a design owner, license owner and/or an entity having the right to produce at least one item in physical form. In some examples, the authorization process may be delegated to a blockchain platform or to processing circuitry associated with a print or manufacturing apparatus.

In this example, the processing circuitry 204 further requests that a transaction is added to the blockchain to indicate that the user's right to print copies of the item should be deprecated by the number of copies which have been produced in physical form (i.e. in this example, five printed copies). This transaction may be associated with the version of the NFT stored on the blockchain such that the NFT is now associated with a right to print just five further copies of the artwork. More generally, therefore, the blockchain may be updated to reflect the remaining number of permitted productions of the item, by deprecating the previous number with the number produced. Of course, the numbers are given purely by way of example and may differ considerably in other cases. In such examples, the apparatus 200 may act as a client of the blockchain platform 202, and one or more nodes of the blockchain platform 202 may process the request to determine if the blockchain should be updated based on the request, for example using a consensus protocol as outlined above.

Content creation, such as graphic content creation, may be a high value activity. Applying an NFT or other digital right associated with a right to produce a digital item in a physical form may provide a separate tradable right, which may be enforced by a manufacturing apparatus (e.g. printer, 3D printer or the like) ecosystem. In some examples, the content creator (or the holder of the copyright) may manage the blockchain, for example via a blockchain client or platform under their control. Accordingly, in some scenarios, blockchain technology may be used to monitor and/or control a permission to produce a physical form of a digital item during the lifespan of the right, or a part thereof.

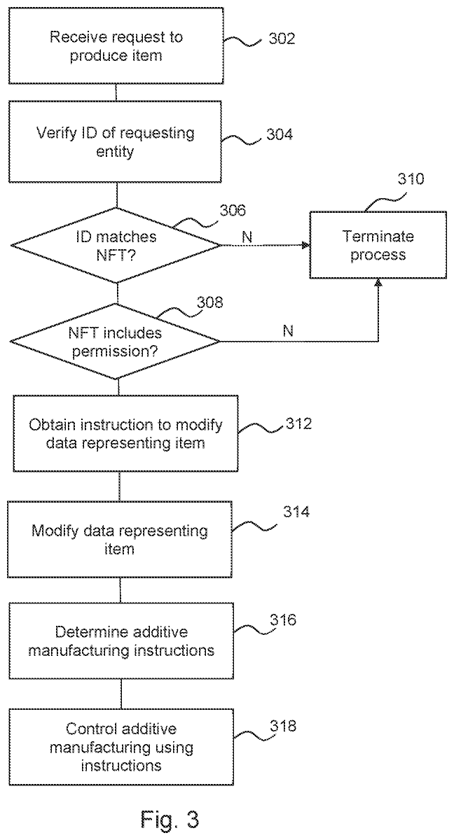

FIG. 3 considers a computer implemented example of a method, which may provide a higher degree of security in relation to the methods set out herein. In this example, the data held by the customer may be modified prior to printing. In some examples, the modification may be based on ‘secret’, or cryptographically secured, data.

In this example, a request to print an item is received at an additive manufacturing apparatus in block 302 (although in other examples, the apparatus may be another 3D manufacturing apparatus, or may comprise a print apparatus, or the like). The request is associated with data representing the item to be printed (which may be supplied with the request, or may be retrieved from an identified location) and an identifier for a digital right, in this example an NFT (for example, the transaction hash of the NFT).

In block 304, the identity of the requesting entity, i.e. the user, is verified. For example, the processing circuitry may request that a password is supplied, or that the user provides an identifying token or biometric data or the like. This may be verified to securely identify the requesting entity.

In block 306, the NFT is identified using the identifier and it is verified that the NFT belongs to the user, for example using the identity verified in block 304 and by reference to a public blockchain held by a blockchain platform. Assuming that this is verified, the method proceeds to block 308. Otherwise, in block 310, the method terminates.

In block 308, the method comprises verifying that the NFT is associated with a right to produce the number of instances of the object specified in the request. If not, the process may terminate in block 310. In other examples, if a number of items specified in the request exceeds the number for which a permission exists, the process may continue based on a reduced number of items to be produced up to the number for which the permission exists.

If a permission to produce the item exists, in block 312, an instruction to modify the data representing the item is obtained. For example, this may be provided from the blockchain platform, or from another entity. In some examples, the instruction is intended to provide the item with a property which is determined from the digital right. For example, the property may comprise a physical property such as print material, color, a translucency, a flexibility, a strength, a conductivity and the like. In other examples, the property may comprise a size, scaling, aspect ratio, dimension or the like. In other examples, the property may comprise data, such as a marking as set out below.

In some examples, the instruction may be provided in a secure manner, for example using cryptographic protection of the data or the like. In such examples, the requesting entity and/or the processing circuitry associated with the production apparatus may store or otherwise hold a key to access the secured data. In some examples, a requesting entity may be requested to provide a data input, for example a password, token or biometric data, before access to the instruction is provided. In other examples, a successful verification in block 304 may also permit access to a secure modification instruction.

In some examples, the modification may comprise a marking. A marking may comprise information or a pointer to information (such as a weblink) about the physical form, its origin and/or the digital right. In some examples, the marking may indicate an edition, for example that the object is the second out of a possible ten authorised versions of the object. A marking may be intended to be overt (e.g., visible on a surface of the item) or covert (e.g., the marking may be intended to be under the surface of the item, not externally visible, not visible to the human eye such that special equipment may be used to read the marking, etc.). For example, different print or build material may be used to form the marking (e.g., a different color, a different type of material that is distinguishable from a surrounding material, a material comprising fluorescent particles, etc.), or the marking may be formed using etching, engraving, protrusions on the surface of the item (e.g. raised lettering) or the like. Such a marking may be readable with or without specialized equipment (e.g., a scan reader, X-rays, tomography, camera, microscope, etc.). A marking may be machine-readable and/or human-readable.

In examples, the marking could for example comprise a replica of a handwritten signature, or a signature color, shape, or some other property which provides an additional characteristic for the object in physical form. The marking may in some examples be associated with the apparatus producing the item and not a generic apparatus. For example, it may comprise a ‘signature’ color of print material which is not widely available. In some examples, the content of the marking comprises a digital signature associated with the authorization process, which may be cryptographically derived, for example using a hashing function or the like. The marking may thereby (or in some other way) provide a link between a produced item in physical form (comprising the content in its marking) and the blockchain ledger. In some examples, a marking may comprise information identifying the apparatus used to generate the item.

Data held in, or in association with, data encoding or embodying the digital right may be used to modify or replace a portion of the data representing the item to be generated by the additive manufacturing apparatus. For example, a color or some other property specified in data representing the item may be changed, a dimension may be altered and/or additional information such as a marking may be added, based on data held in, or in association with, the digital right. In this way, the item when produced in physical form may differ from that specified in the original data. In some examples, this difference may be predetermined (for example, the instruction to modify the data representing the item may be deterministic, such that it has the same outcome on each occasion, given the data held in, or in association with, the digital right). In other examples, the difference may vary, for example on a random or pseudorandom basis.

In summary then, were the data to be used to generate a physical representation of the item without verification, this could result in a different output than when verification is used. This in turn may have an impact on the perceived or intrinsic value of the item in physical form. For example, the modified data may comprise a signature of an artist or designer of the item, and the item may be held to be more valuable with such a signature than without. In other examples, there may be some other modification which increases the value of the item. For example, the modification may be a functional modification of a 3D design, such that an object functions differently without the modification, or may comprise some pertinent or useful information, or a quality such as a signature color or material, which may otherwise be lacking in a printed item. Thus, in some examples, in order to access this part of the design, the user has to complete the verification process outlined above, and items generated outside of the process may be considered to be of lower utility and/or value than items generated following the process.

In block 314, the data representing the item is modified according to the instructions and, in block 316, additive manufacturing instructions are determined based on the modified data. For example, this may comprise generating a ‘voxelised’ representation of the data representing the object and using this to generate instructions as to where material should be placed in generating the object. An example of an equivalent process in a method of producing an item using two-dimensional printing may comprise determining where print materials should be placed on a substrate, for example by defining pixels in image data.

Block 318 comprises controlling an additive manufacturing apparatus using the additive manufacturing instructions, for example to generate the object in a layer by layer manner. In other examples, a different manufacturing process may be used. An example of an equivalent process in a method of producing an item using two-dimensional printing may comprise printing the item on a substrate using one or more print agents.

In summary then, the method may comprise determining, from the content of the digital right (in this example the NFT), at least one instruction for the apparatus such that the item is produced with a property determined from the digital right. The property may be encoded within the right, or associated therewith. In some examples, the property may be cryptographically secured, and may be accessed on successful verification of identification data of the requesting party. Moreover, the method may comprise modifying the data representing the item prior to production based on a property determined from the digital right.

In other examples, it may be the case that the apparatus itself may add modifications or signatures to the item it produces. For example, an apparatus used to produce the item in physical form may add characteristics which may be intrinsic to that apparatus and thus by printing on that apparatus, certain characteristics may be exposed in the item in physical form, wherein those characteristics would not be present if the item was produced using a different apparatus. For example, the apparatus may itself be encoded with instructions which add a marking, which may be any of the markings discussed above, or use a signature color. In other examples, the apparatus may for example add random or pseudo random features to the item produced, such that the item may be substantially unique. For example, the apparatus may make ‘errors’ which may in some cases add to the perceived merit of the work produced as they add a particular character, in a manner analogous with a ‘low-fi’ music playback system, which is preferred by some listeners. In other examples the apparatus may make a functional modification, or may add information.

In some examples, the fact that the item has been produced by a particular apparatus may intrinsically add to its value, for example if the apparatus has some additional distinction (for example being an additive manufacturing apparatus which prints rocket parts, or a printer used to print an original screen play, or the like). Moreover, the use of a particular apparatus, or particular class of apparatus, may reflect an original rights-holder's intentions, and may provide assurance that the article, when produced, is in the form intended. In other words, the use a particular apparatus, or particular class of apparatus may provide a warranty of a predictable and/or intended result. In some examples, this may assure an original rights-holder that, even though they have given up their rights to produce at least some instances of the item, the item will not be produced in an inferior form.

Where the physical form contains some indication that it was produced in an authorized manner, in some scenarios, the methods set out herein may provide a basis for detecting the presence of counterfeit/unauthorized items in the field. In some examples, it may be possible to verify that production of an item was authorized based on a marking or other modification. Moreover, it may be that the modification associated with each produced item may be unique, so that each object can be made in a way that allows each instance of an item to be distinguished from other instances, even if they are produced using the same underlying data. Examples described herein may therefore provide a way to verify the provenance of an item.

Moreover, in some examples, the method may continue with updating the blockchain to indicate that a permission to produce an item has been used, as described above with reference to arrow 218. In such a case, if it is suspected a particular item has been produced without a valid permission, reference may be made to the blockchain to determine if it is feasible/likely that the particular item is an authorized item. For example, this may indicate at least a first owner of the item, and the provenance of the item may be tracked from the established first owner.

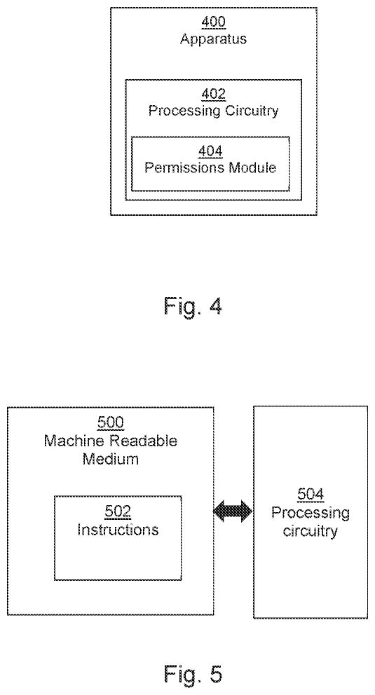

FIG. 4 is a schematic illustration of an example apparatus 400 for at least partially implementing methods described herein (e.g., the methods described in relation to FIGS. 1, 2 or 3).

The apparatus 400 comprises processing circuitry 402, the processing circuitry 402 comprising a permissions module 404, which may be embodied in whole or in part as processing circuitry implementing computer readable instructions.

The permissions module 404, in use of the apparatus 400, analyses a content of a digital right, in this example an NFT, associated with data to determine a reproduction permission associated with the data. The reproduction permission may comprise a permission to produce the item in a physical form, as discussed above. As noted above, an NFT may be provided (for example, over a network, or from a memory thereof) to the apparatus 400 with a request to reproduce an item in physical form. In other examples, an NFT may be accessed based on information associated with such a request. In some examples, the permissions module 404 may, in use of the apparatus 400, verify a reproduction permission with a blockchain platform as described in relation to block 104 of FIG. 1, arrows 214 and 216 of FIG. 2 and blocks 306 and 308 of FIG. 3.

In some examples, the apparatus 400 may comprise processing circuitry which, in use of the apparatus 400, submits a request to update a blockchain storing the NFT when the physical item is generated, for example as described in relation to the arrow 218 of FIG. 2.

Moreover, in some examples, the apparatus 400 generates, or produces, a physical representation of the data according to the reproduction permission. In other words, the apparatus 400 may produce the item in physical form. For example, the apparatus 400 may comprise a print apparatus and/or a manufacturing apparatus, for example an additive manufacturing apparatus, or CNC apparatus. To that end, the apparatus 400 may comprise additional apparatus such as printing components, print material handling apparatus, print material processing components, and the like.

In some examples, the processing circuitry 402 of the apparatus 400 may comprise additional processing modules, which may be embodied at least in part as processing circuitry implementing computer readable instructions. For example, a data modification module may be provided, which may modify data representing an item to be produced in physical form, for example as described above in relation to block 312 and 314. A validation module may be provided, for example to validate a requesting entity, as described above in relation to block 304. In some examples, the apparatus 400 may comprise a cryptographic module, for example to communicate securely with a blockchain platform or other entity such that a modification may be provided in a protected form.

The apparatus 400 may further comprise a tangible machine-readable medium (e.g., ‘memory’) storing instructions readable and executable by at least one processor to perform a method as described in any or any combination of the blocks of FIGS. 1 or 3, or the arrows of FIG. 2.

FIG. 5 schematically illustrates an example machine-readable medium 500 (e.g., a tangible machine-readable medium) which stores instructions 502 which, when executed by processing circuitry 504 (e.g., at least one processor), cause the processing circuitry 504 to carry out certain tasks. In some examples, the tasks may comprise any or any combination of the blocks of FIGS. 1 or 3, or the arrows of FIG. 2. In some examples, the instructions 502 comprise instructions to cause the processing circuitry 504 to retrieve, from data indicative of an ownership right of a data representing an item (e.g. an NFT), data indicative of a production permission associated with the item; and determine production instructions based on the production permission. For example, this may comprise validating a request to print or otherwise produce a physical instance of a digital item against data held in a blockchain, for example in association with an NFT, to determine if the request is authorised. In some examples, determining production instructions based on the production permission may comprise modifying data representing an item to be produced in physical form, for example as described above in relation to block 312 and 314.

In some examples, the instructions 502 comprise instructions to cause the processing circuitry 504 to verify the data indicative of a production permission associated with the item with a blockchain platform.

In some examples, the instructions 502 may cause the processing circuitry 504 to verify a reproduction permission with a blockchain platform as described in relation to any or any combination of block 104 of FIG. 1, arrows 214 and 216 of FIG. 2 and blocks 306 and 308 of FIG. 3. In some examples, the instructions 502 may cause the processing circuitry 504 to validate a requesting entity, as described above in relation to block 304. In some examples, the instructions 502 may cause the processing circuitry 504 to communicate securely with a blockchain platform or other entity such that a modification may be provided in a protected form (e.g. such that it is accessible on production of a cryptographic key).

Any of the blocks, instructions or modules described in relation to the Figures may be combined with, implement the functionality of or replace any of the blocks, instructions or modules described in relation to any other of the Figures. For example, methods may be implemented as machine-readable media or apparatus, machine-readable media may be implemented as methods or apparatus, and apparatus may be implemented as machine-readable media or methods. Further, any of the functionality described in relation to any one of a methods, machine readable medium or apparatus described herein may be implemented in any other one of the methods, machine readable medium or apparatus described herein.

Examples in the present disclosure can be provided as methods, systems or as a combination of machine-readable instructions and processing circuitry. Such machine-readable instructions may be included on a non-transitory machine (for example, computer) readable storage medium (including but not limited to disc storage, CD-ROM, optical storage, etc.) having computer readable program codes therein or thereon.

The present disclosure is described with reference to flow charts and block diagrams of the method, devices and systems according to examples of the present disclosure. Although the flow charts described above show a specific order of execution, the order of execution may differ from that which is depicted. Blocks described in relation to one flow chart may be combined with those of another flow chart. It shall be understood that each block in the flow charts and/or block diagrams, as well as combinations of the blocks in the flow charts and/or block diagrams can be realized by machine readable instructions.

The machine-readable instructions may, for example, be executed by a general-purpose computer, a special purpose computer, an embedded processor or processors of other programmable data processing devices to realize the functions described in the description and diagrams. In particular, a processor or processing circuitry, or a module thereof, may execute the machine-readable instructions. Thus, functional modules or apparatus (for example, the apparatus 200, 400) and other devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine-readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by block(s) in the flow charts and/or in the block diagrams.

Further, the teachings herein may be implemented in the form of a computer program product, the computer program product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the scope of the present disclosure. It is intended, therefore, that the method, apparatus and related aspects be limited by the scope of the following claims and their equivalents. It should be noted that the above-mentioned examples illustrate rather than limit what is described herein, and that many implementations may be designed without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising, by processing circuitry:
receiving a request from a user to produce an item represented by data in a physical form and an indication of a digital right associated with the item;
determining, from the content of the digital right, if the user has permission to produce the item in physical form; and
when the user has permission to produce the item, instructing an apparatus to produce the item in physical form.

2. A method according to claim 1 wherein the digital right is a Non-Tangible Token, NFT.

3. A method according to claim 1 wherein the apparatus is a print apparatus.

4. A method according to claim 1 further comprising determining if the permission is a permission associated with a particular apparatus or class of apparatus and, when the user has permission to produce the item on the particular apparatus or class of apparatus, instructing that particular apparatus or class of apparatus to produce the item in physical form.

5. A method according to claim 1 further comprising determining, from the content of the digital right, at least one instruction for the apparatus such that the item is produced with a property determined from the digital right.

6. A method according to claim 5 comprising modifying the data representing the item prior to production based on data determined from the digital right.

7. A method according to claim 1 wherein the permission is associated with a number of permissible productions of the item.

8. A method according to claim 1 further comprising, by the processing circuitry, requesting that a blockchain is updated with an indication that a permission to produce the item has been utilised.

9. A method according to claim 1 wherein determining if the user has permission to produce the item in physical form comprises requesting validation of the permission from a blockchain platform.

10. Apparatus comprising:
processing circuitry comprising a permissions module to analyse the content of an NFT associated with data to determine a reproduction permission associated with the data,
wherein the apparatus is to generate a physical representation of the data according to the reproduction permission.

11. Apparatus according to claim 10 which comprises one of a print apparatus and a manufacturing apparatus.

12. Apparatus according to claim 10 wherein the permissions module is to verify the reproduction permission by reference to a blockchain platform.

13. Apparatus according to claim 10 wherein the processing circuitry is further to submit a request to update a blockchain storing the NFT when the physical representation of the item is generated.

14. A machine-readable medium comprising machine-readable instructions which, when executed by a processor, cause the processor to:
retrieve, from data indicative of an ownership right of data representing an item, data indicative of a production permission associated with the item; and
determine production instructions based on the production permission.

15. The machine-readable medium of claim 14 further comprising machine-readable instructions which, when executed by the processor, cause the processor to:
verify the data indicative of a production permission associated with the item with a blockchain platform.
